(19) United States
(12) Patent Application Publication
(10) Pub. No.: US 2017/0330248 A1
(43) Pub. Date: Nov. 16, 2017

(54) Portable Electronic Device and Method for Displaying Data Thereon

(71) Applicant: AdPhone LLC, Coral Gables, FL (US)

(72) Inventors: Jorge Gomariz, Coral Gables, FL (US); Emmanuel Herzog, Coral Gables, FL (US); Charles Russell, Coral Gables, FL (US); Rene Sanabria, Coral Gables, FL (US); Nilesh Wickham, Coral Gables, FL (US)

(21) Appl. No.: 15/597,140

(22) Filed: May 16, 2017

Related U.S. Application Data
(60) Provisional application No. 62/336,923, filed on May 16, 2016.

(51) Int. Cl. G06Q 30/02; G06F 3/0481; G06F 17/30

(52) U.S. Cl. CPC G06Q 30/0277; G06Q 30/0269; G06F 3/0481; G06F 17/30861

(57) ABSTRACT

Disclosed are a portable electronic device, such as a smartphone with a touchscreen, and a method for displaying a graphical user interface (GUI) thereon. The GUI has a first area enabling a device user to interact with a display application designed to be unstoppable by the user, and a second area enabling the user to interact with other applications. The device executes three applications: the display application, a service, and a plugin. The display application displays data in the first area of the GUI—these data may include advertisements. The service uninstalls interfering applications, such as advertisement blockers; updates the three applications when new versions issue; and ensures that the display application and the plugin are always executing. The plugin ensures that the display application and the service are always executing. The three applications may execute using elevated permissions, to prevent them from being stopped or disabled.

### CROSS-REFERENCE TO RELATED APPLICATION

This application claims the benefit of U.S. Provisional Application No. 62/336,923, filed May 16, 2016, the contents of which are incorporated by reference in their entirety.

### TECHNICAL FIELD

The present invention relates to a graphical user interface for a small display screen, and more particularly to reserving screen space for display of data on a portable electronic device, such as a smartphone.

### BACKGROUND ART

A smartphone is a portable electronic device having an operating system that combines features of a personal computer with features useful for mobile or handheld use. Smartphones can improve a person's quality of life and productivity by bringing information and services to the person, regardless of location. However, because of the technological complexity of smartphones, they are often expensive, and therefore unaffordable to those of limited means. Therefore, there is a need for smartphone providers to offer free or low-cost smartphones to consumers.

Some computer hardware providers have obtained compensation for their products from software developers using a technique called “software bundling.” For example, Microsoft Corporation of Redmond, Wash. has long paid personal computer manufacturers to install its software on their products prior to sale, thereby compensating the manufacturers and subsidizing the cost of such computers to end consumers. However, software bundling may not be a viable compensation strategy for some smartphone makers, for a variety of philosophical or business-related reasons, or it may insufficiently lower the purchase price to reach the target market.

One way that web-based service providers have provided free services is by the use of advertising. Rather than charge users an access or subscription fee, some websites provide services at no cost to users, in exchange for a user being required to engage with an advertising experience. For example, the video-providing service of YouTube, LLC of San Bruno, Calif. sometimes requires viewers to watch a short video advertisement prior to displaying its requested video. Alternately, a “banner” advertisement may appear over a portion of the video. Other web service providers have had success obtaining revenue by the use of banner ads.

However, a major problem with web-based advertising is that it is subject to “blocking”; that is, being automatically hidden from view by software installed on a viewer's computer. The information obtained from a web service used to display the service in a browser is typically in the form of hypertext markup language (HTML). Ad blocking software analyzes this HTML before it is displayed, identifies advertisements using a variety of pattern-matching techniques, then prevents the browser from displaying those portions of the HTML that contain advertisements. In some cases, ad blocking software prevents loading the advertising content from an advertising server. Ad blocking software deprives the service provider of revenue, because providers often derive revenue from advertisers based on the number of times an advertisement is downloaded from the server, or from the number of times a viewer engages with an advertisement (for example, by clicking it).

### SUMMARY OF ILLUSTRATIVE EMBODIMENTS

In accordance with illustrative embodiments, a smartphone provides advertisements that cannot be closed or blocked by the phone's user. The phone executes an application that displays a window showing advertisements from different vendors based on the location, age, gender, or other demographic information of the user, using screen space separate from any user-selected application. The advertisements may be presented in HTML, and may be obtained from a variety of known web-based advertising providers. The application asks the user to accept the advertiser's privacy policy, as well as to login with a social networking service (for example, the service provided by Facebook, Inc. of Menlo Park, Calif.) in order to gain access to a user-specific profile and personal information. The application tracks the number of ads displayed during a given day by a given phone, by sending an International Mobile Station Equipment Identity (IMEI) number from the phone to a web service.

In order to display ads continually, the application must be uninterruptable, and in case of a crash, needs to restart on its own. The application preferably handles errors in a silent manner, and operates with sensible default behavior when the phone does not have any Internet connection or an available location. The application may support different mobile operating systems; for example, any version of Android that is 4.4.2 (Kit-Kat) or higher. It may also support multiple screen sizes and/or resolutions. The application may be able to auto-update itself without any user input or acceptance. Finally, the application detects other application(s) installed on the device that blocks ads, determines if it violates the terms and agreement of the privacy policy, removes the offending application, and notifies the user of the application removal.

Therefore, a first embodiment of the invention is a method of displaying, on a display screen of a portable electronic device, a graphical user interface (GUI). The GUI has a first area enabling a user of the portable electronic device to interact with a display application designed to be unstoppable by the user. The GUI also has a second area enabling the user to interact with a second application. The method includes executing, by the portable electronic device, the display application, and a service application, and a plugin application. The method also includes executing, by the portable electronic device, a home screen application that is displayed in the second area of the GUI, the home screen application enabling the user to choose the second application for display in the second area of the GUI.

The display application is configured to perform three processes at a first regular interval, which may be approximately every 30 seconds. The first process is to transmit, to a server via a data network, personal data pertaining to the user. The personal data may include (1) data that uniquely identify the user to the server, or (2) data that indicate a condition of either or both of the user and the portable electronic device, or (3) a combination of identifying and condition-indicating data. For example, data that uniquely identify the user to the server may include an IMEI number; data that indicate a condition of the user may include an age, gender, or other demographic information of the user; and data that indicate a condition of the portable electronic device may include a location sensed by the portable electronic device (in which case the method further comprises sensing the location by the portable electronic device). The second process is to receive, from the server via the data network, data having been selected by the server as a function of the personal data. The received data may include, for example, an advertisement for display in the first area of the GUI. The third process is to display, in the first area of the GUI, the received data.

The service application is configured to perform three processes at a second regular interval, which may be approximately every 10 minutes. The first process is to uninstall, from the portable electronic device, any application whose operation interferes with operation of the display application, the service application, or the plugin application. The second process is to update the installation of the display application, the service application, or the plugin application. The third process is to enable, if disabled, and restart, if stopped, either or both of the display application and the plugin application.

The plugin application is configured to, at a third regular interval which may be approximately every 5 minutes, enable, if disabled, and restart, if stopped, either or both of the display application and the service application.

Variations on the method are contemplated; it should be appreciated that these variations are not mutually exclusive. In one variant, executing the display application, or the service application, or the plugin application comprises executing using a permission setting that prevents the user from stopping the application, or disabling the application, or both stopping and disabling the application. Another variant includes, in response to receiving a selection by the user of the first area of the GUI, executing an application that is associated with the data displayed in the first area of the GUI.

In another variant, the service application is further configured to determine the applications whose operation interferes with operation of the display application, the service application, or the plugin application according to a fourth regular interval, which may be approximately every 24 hours. This determination is achieved by transmitting, to the server via the data network, a request to obtain an updated list of such applications; and receiving, from the server via the data network, a response including data that identify the applications.

Another variant includes configuring a size of the first area of the GUI according to a format of the data received by the display application from the server. In still another variant, displaying the data received by the display application from the server includes formatting the data for graphical display.

A second embodiment of the invention is a tangible memory in which is non-transitorily stored computer program code for the display application, the service application, and the plugin application, each such application being capable of execution by a portable electronic device, the collective execution of the applications by the portable electronic device resulting in performance of the method of the first embodiment, or one or more of its variants.

A third embodiment of the invention is a portable electronic device. The device includes a touchscreen, a data network port capable of coupling to a data network for transmission and reception of data with a server, a sensor capable of determining a location of the portable electronic device, a microprocessor, and a memory. The microprocessor is configured to execute a multitasking operating system, the operating system facilitating data access, by one or more applications, to the touchscreen, and the data network port, and the sensor via an application programming interface (API). The memory stores computer program code for performing the method of the first embodiment, or one or more of its variants.

### BRIEF DESCRIPTION OF THE DRAWINGS

The foregoing features of embodiments will be more readily understood by reference to the following detailed description, taken with reference to the accompanying drawings, in which:

FIG. 1 is a depiction of a portable electronic device whose screen is displaying a graphical user interface (GUI) that is divided into two non-overlapping display areas in accordance with an embodiment of the invention;

FIG. 2 is a schematic representation of relevant hardware components existing within the portable electronic device of FIG. 1 and its environment;

FIG. 3 is a schematic representation of relevant logical components of the portable electronic device of FIG. 1;

FIG. 4 is a flowchart showing processes used by a display application of the portable electronic device to display the GUI depicted by FIG. 1;

FIG. 5 is a flowchart showing processes used by a service of the portable electronic device to display the GUI depicted by FIG. 1; and

FIG. 6 is a flowchart showing processes used by a plugin of the portable electronic device to display the GUI depicted by FIG. 1.

### DETAILED DESCRIPTION OF SPECIFIC EMBODIMENTS

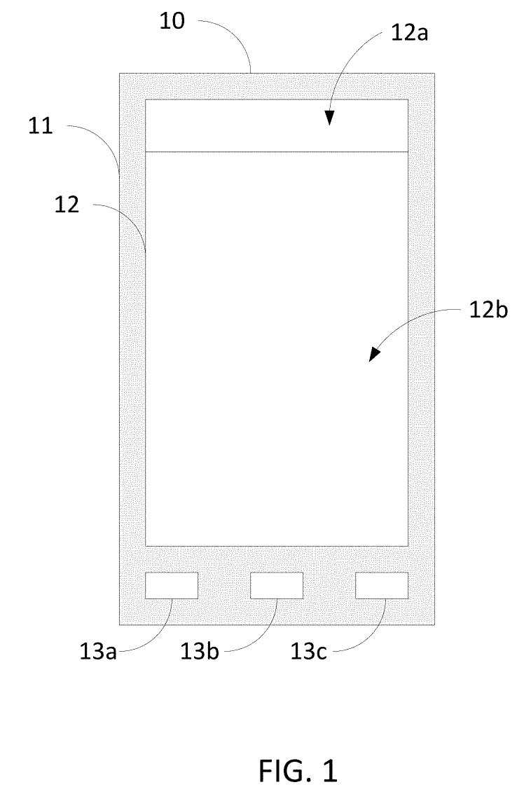

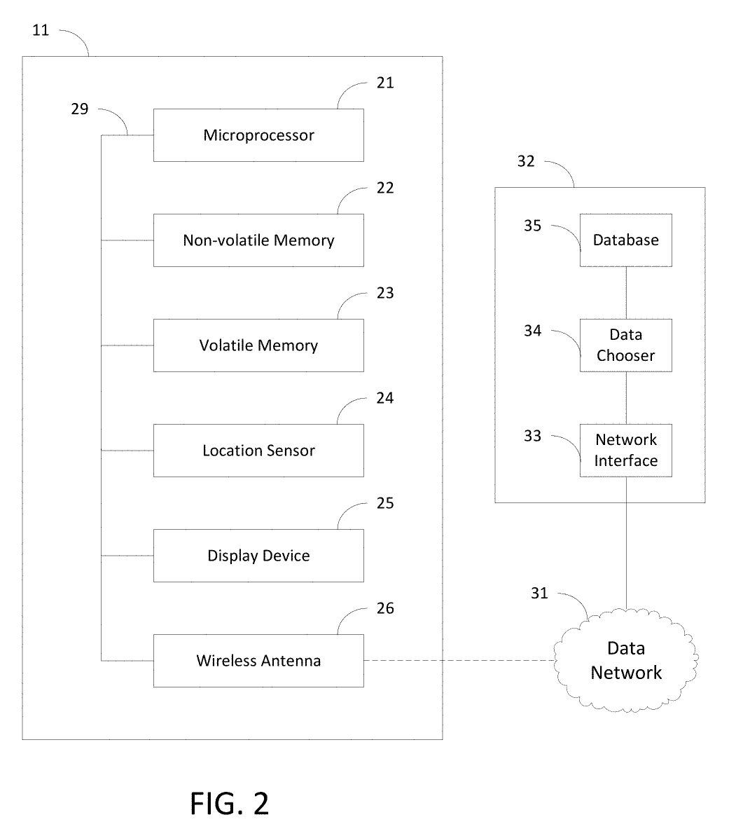

FIG. 1 is a depiction of a portable electronic device 10, whose screen is displaying a graphical user interface (GUI) that is divided into two non-overlapping display areas in accordance with an embodiment of the invention. It should be appreciated that the shape of the device, its components, and their relative locations as depicted in FIG. 1 are illustrative only, and that the invention may be embodied in devices appearing differently so long as those devices operate according to the techniques disclosed herein. To that end, the portable electronic device 10 may be any such device known in the art, such as a smartphone, personal digital assistant (PDA), tablet computer, or similar device. The portable electronic device 10 includes a housing 11 that houses hardware components shown in FIG. 2.

Visible on the surface of the portable electronic device 10 are a display screen 12 for showing a graphical user interface (GUI), and buttons 13a, 13b, 13c. The display screen 12 may be a touchscreen, as is known in the art, or other display device that enables a user of the portable electronic device 10 to interact with the GUI. The buttons 13a, 13b, 13c may be used to perform industry-standard operations, such as causing the GUI to display a list of running or suspended user-selected applications, causing the GUI to display a “home screen,” or causing the GUI to display a “previous screen” within the context of a logical flow of a particular user-selected application, or other such purposes as known in the art.

In accordance with illustrated embodiments of the invention, the GUI is divided into two non-overlapping display areas 12a, 12b. The first display area 12a is used to display data obtained from a server 32 (shown in FIG. 2) on a rotating or changing basis. A user of the portable electronic device 10 may interact with the first display area 12a by clicking or gesturing within it, but is unable to hide it, move its location on the screen 12, or otherwise tamper with its functioning. The second display area 12b is used to display a default, “home screen” application provided by an operating system of the device, or applications of the user's choosing. The user may select such other applications using the home screen application, the buttons 13a, 13b, 13c, or other hardware controls not shown (such as a power button, volume control, or other such controls known in the art).

FIG. 2 is a schematic representation of relevant hardware components existing within the portable electronic device 10 and its environment. The housing 11 contains hardware components known in the art to be needed or useful for providing a portable electronic device 10. Thus, the housing 11 contains a microprocessor 21, a non-volatile computer memory 22, a volatile memory 23, a location sensor 24, a display interface 25, a wireless antenna 26, and other hardware (not shown) customarily found in such devices.

The microprocessor 21 may be any microprocessor capable of executing programmed instructions. The microprocessor 21 may be, without limitation: a central processing unit (CPU) core, a digital signal processor (DSP), a graphics processing unit (GPU), an embedded processing core, a microcontroller, or an integrated circuit containing any number of these.

The non-volatile memory 22 may be any memory that retains data when electrical power is removed. In illustrative embodiments the non-volatile memory 22 is used for storing instructions for execution by the microprocessor, and in some embodiments, for storing related data. The non-volatile memory may be, without limitation: a mechanical storage device such as a hard disk or optical disk, or a non-volatile random-access memory (NVRAM) such as flash memory or a programmable read-only memory (PROM), whether or not erasable for reprogramming.

The volatile memory 23 may be any memory that retains data only when electrical power remains applied. In illustrative embodiments the volatile memory 23 is used for transitorily storing data used by the microprocessor when executing the instructions, and may be, without limitation: a dynamic random-access memory (DRAM) or a static random-access memory (SRAM), whether or not integrated in a single integrated circuit with another component.

The location sensor 24 may be any sensor that is capable of determining a location of the portable electronic device 10 in reference to a known locating system. As is known in the art, there are several techniques for locating a portable electronic device 10 using radio signals, including triangulation (measuring directions between multiple known locations, such as cellular communications stations or neighboring WiFi base stations), trilateration (measuring absolute distances to multiple known locations), multilateration or MLAT (repeatedly measuring the differences in distances to multiple known locations), and other technologies including the global positioning system (GPS). The location sensor 24 may be, without limitation, any device that is used for participating in one of the locating techniques known in the art.

The display device 25 may be any device for displaying information in an intelligible visual or tactile form. In illustrative embodiments, the display device 25 includes the display screen 12, but also is used to convert digital data, representing a GUI having two areas in accordance with an embodiment of the invention, into signals for use by the display screen 12.

The wireless antenna 26 may be any antenna capable of coupling to a data network 31 for transmission and reception of data. The wireless antenna 26 has electrical characteristics (such as a physical length and material) that is related to the frequency on which it communicates data, or the distance through which the data must travel. The wireless antenna 26 may be designed for communication using, without limitation: satellite communications systems, cellular and personal communications service (PCS) systems, radio and spread spectrum systems, or other systems known in the art. In this connection, the wireless antenna 26 may be coupled to a specialized processor (not shown) for processing data signals before transmission and after reception. It should be appreciated that, in some embodiments, the wireless antenna 26 may be replaced with a wired data network port, for example to couple to a wired data network using Ethernet.

In accordance with illustrative embodiments, the wireless antenna 24 is used to couple the portable electronic device 10 to a data network 31 for transmission and reception of data with a server 32. The data network 31 may be a conventional data network, such as the Internet. The server 32 may be a conventional server or other computer system.

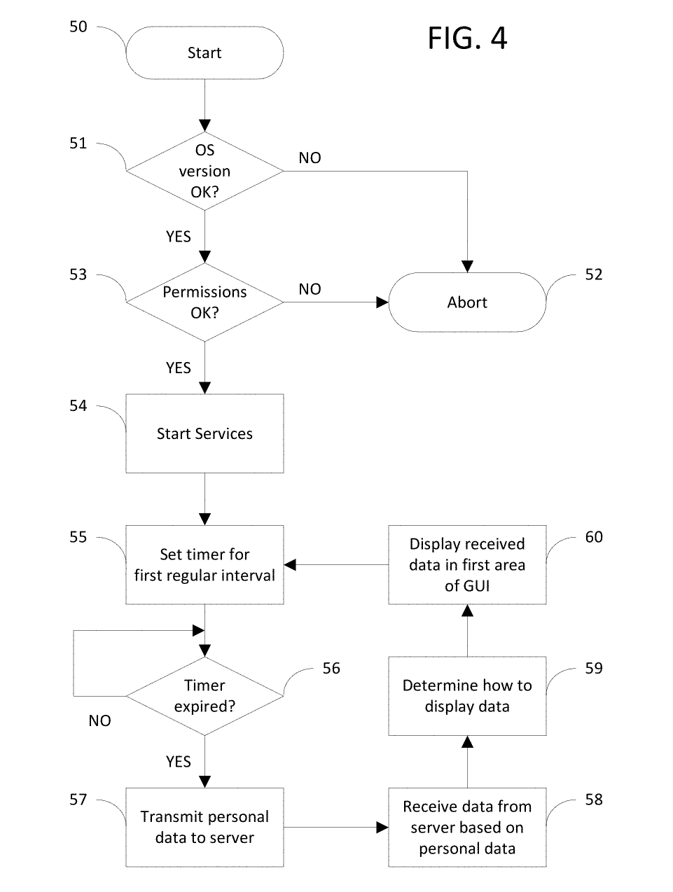

Relevant to embodiments of the present invention, the server 32 includes a network interface 33 for transmission and reception of data with a large number of portable electronic devices 10. The server 32 also includes a data chooser 34, which may be any device capable of processing personal data received from a portable electronic device 10 and determining responsive data, as described in more detail connection with FIG. 4. In various illustrative embodiments, and without limitation, the responsive data are advertisements. The server 32 also includes a database 35, which may be any storage known in the art, and which is used to store data used by the data chooser 34.

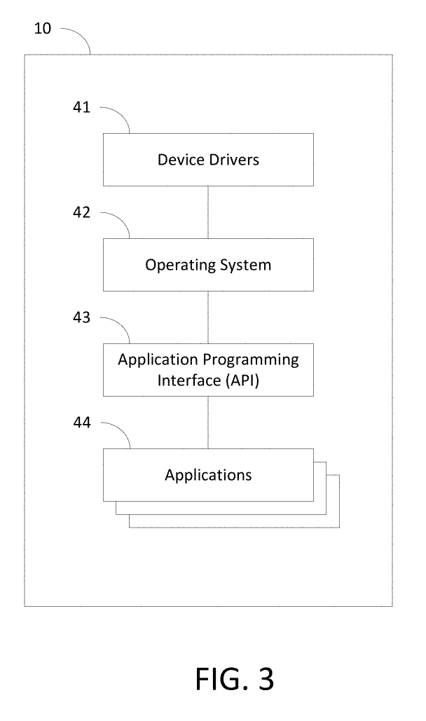

FIG. 3 is a schematic representation of relevant logical components of the portable electronic device 10. While the technical description herein is made concrete by referring to the Android smartphone technology provided by Google, Inc. of Mountain View, Calif., it should be appreciated that persons having ordinary skill in the art pertaining to other smartphone devices and technologies may apply the techniques described herein to provide equivalent functionality for those other devices and technologies without departing from the scope of the invention, as defined by the claims.

As is known in the art, a smartphone 10 may include device drivers 41, an operating system 42, an application programming interface (API) 43, and one or more executing applications 44. The device drivers 41 provide a uniform interface to command hardware (e.g., the location sensor 24) and certain software that simulates hardware (e.g., a ‘null device’ that discards all data sent to it).

The operating system 42 includes a kernel and applications. The kernel of the operating system 42 is software that executes with elevated privileges, and is the only software that is permitted to directly command the hardware via device drivers 41. The kernel also provides various other services (e.g., process scheduling, interrupt signaling, inter-process communication, and countdown timing) in response to requests known in the art as “system calls.” Each system call is an interface between an application operating with relatively few privileges, and the kernel. The operating system 42 also includes applications (not shown) that provide system configuration and maintenance functions that can be performed with fewer privileges than the kernel uses.

Often, the kernel of the operating system is written in one programming language (e.g., the C programming language originally developed by Dennis Ritchie at Bell Labs, now Nokia Bell Labs of Murray Hill, N.J.), while applications meant for end users are written in another language (e.g., the Java® programming language, developed by Oracle Corporation of Redwood Shores, Calif.). In particular, this is true of the Android operating system, which provides access to system calls as part of an API 43. The use of the API 43 as a separate software layer permits Android to package system calls within programming constructs, such as classes and methods, that are friendly to developers. Moreover, the use of the API 43 permits Android to provide additional computational functions, thereby encouraging third-party development of applications 44 beyond those provided with the operating system 42.

Three such applications 44 are relevant to illustrative embodiments of the present invention. These applications 44 are: a display application, a service application, and a plugin application. The purpose of the display application is to display data that may be relevant to a user of the portable electronic device 10, on the display screen 12, and more particularly, in a first area 12a of the display screen. The purpose of the service application is to guarantee that the display application is running at all times, and to update other applications 44 in the portable electronic device 10. The purpose of the plugin application is to ensure that the display application and the service application are running at all times. Flowcharts showing processes used by each of these applications 44 are shown in FIGS. 4-6. For purposes of concreteness, the displayed data are described herein as advertisements, but it should be appreciated that any data may be displayed according to these techniques.

To facilitate security against tampering, these three applications should be installed in a directory that gives them full access to operating system privileges. In the Android system, this is the “system/priv-app” directory. In this way, the display application, the service application, and the plugin application may execute having a permission setting that prevents a user of the portable electronic device 10 from stopping or disabling any of the applications.

Each application has an internal timer that keeps it active, so the operating system 42 does not consider it as an obsolete or sleeping application. Each application may use expiration of this timer to check the others, after which the timer is restarted. The timer duration may be short, for example five seconds, to ensure that data are displayed without lengthy interruption. Special handling of errors or exceptions is performed so that the application do not crash and then are unable to restart. In order to do this, an internal Error-Handler catches all exceptions in each application, and assures the application does not crash if an unhandled exception is thrown.

FIG. 4 is a flowchart showing processes used by a display application of the portable electronic device to display the GUI depicted by FIG. 1. In process 50, the display application is initialized by the operating system, and begins executing. In process 51, the display application determines whether the operating system has the correct version. In some embodiments, a minimum version number is required for the display application to perform all of its functions. Thus, in one embodiment, version 4 or higher of the Android Operating System is required. If the version is too low, the display application moves to process 52, in which it aborts operation.

If the operating system version is good, in process 53 the display application determines whether any permissions are required for it to properly execute. If so, the display application will display a screen to the user that allows the user to provide the required permissions. For example, the user may be required to login to a social networking site, such as Facebook, or allow the display application to access the location sensor via the API framework to obtain the location of the device. If permissions are required but the user declines to grant them, the display application moves to process 52, in which it aborts operation.

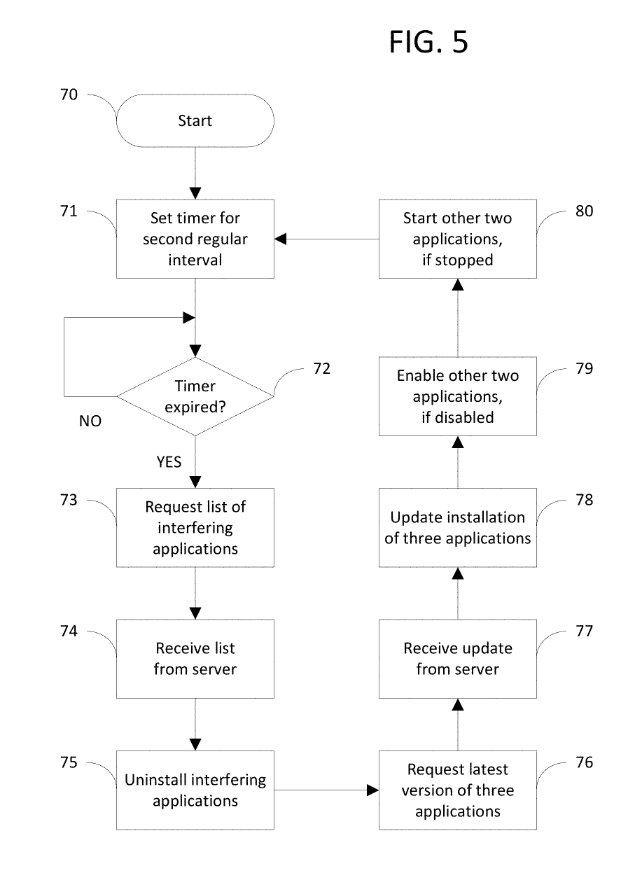

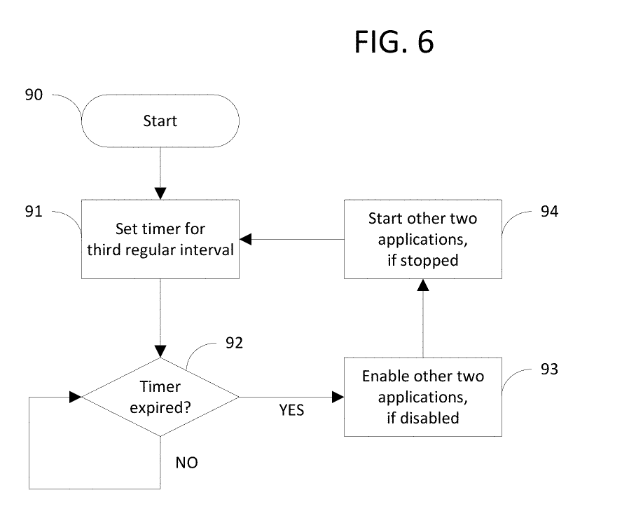

If the display application has all necessary permissions, then in process 54 it uses the API to launch various other applications as background services (i.e., as not providing user interactivity). In particular, the display application starts the service application and the plugin application, described in more detail below in connection with FIGS. 5 and 6. With respect to the Android framework specifically, each background application is launched using the “START_STICKY” flag, in order for the operating system 42 to know that this application is a service that needs to be restarted if it crashes, for example due to the system running out of computing resources. However, restarting services need not be instantaneous, so if one of the service displaying the advertisements crashes, the user may momentarily be presented a GUI that does not show advertisements. One solution is to attach the service to an Ongoing Notification. This tells the operating system that the service has some foreground capabilities, so the operating system does not close it if it needs to release resources.

Once these other applications have been started, the display application enters a permanent loop in which it displays data in the first area 12a of the GUI. To begin the loop, in process 55 the display application uses the API framework to set a timer to expire after a first, regular interval. The first interval represents a duration of time in which to display particular data in the first area 12a of the GUI, before retrieving and displaying new data. In some embodiments, the first interval is approximately 30 seconds, although other embodiments may use a longer or shorter duration.

Next, in process 56 the display application waits for the timer to expire. It should be appreciated that the user may choose to interact with the display application during this time. In particular, the display application may receive an “event” from the operating system that indicates the user has touched the display screen, and in particular the first area 12a of the GUI in which the data are displayed. The event may indicate that the user clicked a particular location, or gestured within the first area, or otherwise selected the first area. If the display application receives notice of such an event from the operating system, the display application may responsively execute another application that is associated with the data displayed in the first area 12a of the GUI. For example, the associated application may be a web browser, opened to a website related to the content of the displayed data. If the displayed data are an advertisement, the website may be that of the advertiser, or another site chosen by the advertiser to be associated with the particular ad. It should be appreciated that the foregoing example is not limiting, and that the display application may take any action in response to receiving notification of a selection event.

Once the timer has expired, the display application obtains new data to display in the first area 12a of the GUI. To obtain the data, a separate server provides a web service function that instructs the application which data to display, as well as the format in which it is to be expected. Thus, in process 57 the display application transmits, to the server via a data network, personal data pertaining to the user. The personal data may include data that uniquely identify the user to the server, including an international mobile equipment identity (IMEI) number. The personal information from the user also may include the user's age, gender, other demographic information, and any other authorized information provided by the user when logging into the social network, as well as any necessary parameters needed to obtain valid data. The personal data also may include a location of the portable electronic device, as sensed by a location sensor, if the sensor is active and a location signal can be obtained. The web service uses these personal data to determine the data for display on the portable electronic device. Various factors used by the web service may include, in the case of an advertisement: an advertising network, a type of advertisement, and the frequency an advertisement should be shown based on business logic.

In process 58, the display application receives the responsive data from the server, and in process 59, the display application determines how to display the responsive data based on its type (e.g., whether it should be rendered in HTML, HTML5, JavaScript, or some other format). To support multiple data formats, a floating window is used. The display application causes the GUI to display a window in the first display area 12a in a manner that prevents the user from minimizing it or closing it, while still permitting the user to engage with an advertisement displayed within the window.

To support multiple data types from multiple networks, as well as multiple data formats, the floating window has a container that changes depending on the requirements of each type of data that needs to be displayed. If the data should be rendered as HTML, HTML5, JavaScript, or CSS, the display application initializes a WebView container to display the data. However, if the data must be streamed, or otherwise retrieved from an API distributed by the data provider—for example, a software development kit (SDK)—then the display application obtains the data by communicating with the SDK using a unique identifier provided by the server. Various advertising networks, such as AdMob and DoubleClick, provide such SDKs to software developers. The SDK provides an appropriate container object for use by the display application, and must be locally accessible to the display application.

The display application launches a floating window container that is able to change between views preferably to support the different data formats that are required. This may be done by creating a FloatingView and attaching it to a timer. When the timer expires then the view will clear the container and display the desired data. The created View has full access to the service context, in order to check if the data are being shown or not.

In some cases, a response is not obtained from the server in a manner timely enough to provide a pleasing user experience. If so, then the display application shows default data, such as a Facebook advertisement. However, if Facebook is unreachable or no Internet connection is available, then a static banner (such as a corporate logo) is shown until connectivity is restored.

Once the appropriate View object has been created from the received data, in process 60 the display application displays the object having the data in the first area 12a of the GUI. The first area 12a of the GUI is reserved for exclusive use by the display application, and may be provided as an extended status bar. That is, in accordance with some embodiments, a configuration file in the smartphone operating system is altered to increase the height of a status bar, and the data are displayed in the added space. To ensure that the existing status bar functionality continues as expected, various other changes may be made, such as altering a gravity value.

Data displayed in the first display area 12a, especially advertisements, may be required to satisfy various usability and revenue requirements. For example, each advertisement may be displayed for 30 seconds (or some other duration), until a new ad is displayed. Ads may not be rendered or cycled when the screen is off or the floating window is not visible (for whatever reason). Multiple ads cannot be shown at the same time. When changing between ad networks, the new ad replaces the old ad, so that they don't overlap each other. Ads may be displayed based on location, if and only if a location is obtained from the phone. Because the data are displayed in a status bar, the display application can be configured, using known techniques, to permit a user to execute a full-screen application that hides the status bar (and the data). Also, the display application can be configured to use reduced power when the smartphone is not in active use, and when no Internet connection is available. Those having ordinary skill in the art may appreciate other restrictions on the display of data, especially advertisements. Once the data have been displayed in process 60, the display application loops back to process 55, in which it resets the timer, and the processes repeat.

FIG. 5 is a flowchart showing processes used by a service of the portable electronic device 10 to display the GUI depicted by FIG. 1. In process 70, the service application is initialized by the operating system (at the request of the display application in process 54), and begins executing. In process 71, the service application uses the API framework to set a timer to expire after a second, regular interval. The second interval represents a duration of time after which to ensure that the suite of applications continues to function properly. In some embodiments, the second interval is approximately 10 minutes, although other embodiments may use a longer or shorter duration. In process 72, the service application waits for the timer to expire.

Once the timer has expired, the service application performs three tasks: uninstalling applications that may interfere with the operation of the display, service, and plugin applications; updating the latter applications, if newer versions are available; and enabling and/or restarting the display and plugin applications in case they are not running. Thus, in process 73, the service application requests from the server a list of applications that may interfere with the operation of the display, service, and plugin applications. In process 74, the service application receives the list from the server. In process 75, the service application uninstalls any applications on the received list that are presently installed on the portable electronic device 10. After deletion, an alert message is displayed to the user, letting the user know that there was a violation of the Terms and Conditions of the device, the name of the offending application, and that the application has been deleted.

Next, in process 76, the service application requests from the server the latest version of the display, service, and plugin applications. Ordinarily, this is done by transmitting a version number to the server, which the server compares against the version numbers of the most up-to-date applications. If the version numbers are the same, then in process 77 the service application receives an indication that this is so. Otherwise, in process 77 the service application receives a link to the application program code to permit it to be downloaded. In process 78 the service application then downloads, in the background, the latest software version for the application in question, updates it in place, and restarts the application without requiring any user interaction or additional permission (bypassing Google Play or any Android “Unknown sources” selection).

The service application may be configured to use a device-specific, ancillary application to modify any firmware or software in the portable electronic device 10, on demand, rather than performing the update itself. This functionality allows for the service application to be pre-installed on a wide variety of devices that do not use it as-sold. The ancillary application waits for notification from the server (most likely triggered by a request from a mobile operator), to convert the device to operate in accordance with various embodiments of the invention by dividing the GUI into two areas and displaying advertisements. Using this feature, the Original Device Manufacture (ODM) need not make any the firmware modifications prior to sale. Instead of the service application itself making changes to the status bar and navigation bar (i.e., changes requiring a high permission level), the ODM of each device compiles the ancillary application with its own Android Manufacturing Key. This gives the ancillary application the required permissions to be able to make the changes on demand.

As an added feature, adding firmware independence as just described allows for embodiments to directly, or in partnership with a mobile operator, give the end user a billing credit for receiving advertising on their device via the display application. This feature permits advertiser revenue to be split between the ODM and the advertising application developer, or between any other parties, transparently to the end user.

Finally, in process 79, the service application determines whether the display application or the plugin application are disabled (i.e., prevented from executing), and if so, re-enables them. Either of the other applications may be disabled for a number of reasons, including having been deliberately disabled by a user of the portable electronic device 10. Regardless of the reason for disablement, in process 79 the service application re-enables either or both of the other two applications that was disabled. Then, in process 80, the service application determines whether the display application or the plugin application are stopped (i.e., not currently executing), and if so, starts them. Either of the other applications may be stopped for a number of reasons, including having experienced a terminal error. Regardless of the reason for the stoppage, in process 80 the service application restarts either or both of the other two applications that was disabled.

Having completed its three tasks, the service application returns to process 71, in which it resets the timer, and the processes repeat. In subsequent loops, the timer may be set to a fourth regular interval, such as 24 hours, to perform request for data from the server, so as to reduce the data traffic load on the server. This may be done by setting a timestamp on a file in the system, and checking for expiration of the fourth regular interval in processes 73 and 76 prior to requesting data from the server. However, processes 79 and 80 are performed at the expiration of the second regular interval—every 10 minutes, in accordance with one illustrative embodiment.

FIG. 6 is a flowchart showing processes used by a plugin of the portable electronic device to display the GUI depicted by FIG. 1. In process 90, the plugin application is initialized by the operating system (at the request of the display application in process 54), and begins executing. In process 91, the plugin application uses the API framework to set a timer to expire after a third, regular interval. The third interval represents a duration of time after which to ensure that the suite of applications continues to function properly. In some embodiments, the third interval is approximately 5 minutes, although other embodiments may use a longer or shorter duration. In process 92, the plugin application waits for the timer to expire.

Once the timer has expired, in process 93 the plugin application determines whether the display application or the service application are disabled (i.e., prevented from executing), and if so, re-enables them. Then, in process 94, the plugin application determines whether the display application or the service application are stopped (i.e., not currently executing), and if so, starts them. Having completed its task, the plugin application returns to process 91, in which it resets the timer, and the processes repeat.

In accordance with some embodiments, the display application or the service application or both may direct all data traffic, associated with operation of the disclosed system, to a particular Internet protocol (IP) address via a proxy. In this way, the mobile operator from which the user receives data services may recognize that the data are related to the disclosed system, and refrain from charging the user for advertising-related data, thereby providing an incentive to end users to use embodiments of the invention without tampering. Such data include, but are not limited to: ad requests, ad content, error logging, authorized user data, usage logs, and target pages of the advertisements themselves. In response to receiving selection of an advertisement by a user, the display application will open a custom web browser in which the data is transmitted through the proxy, and not through the device's data connection. The display application may use the API 43 to recognize when the device is connected to WiFi or through a mobile data connection. The proxy is only used for traffic that is connected through the mobile data connection.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

Oracle and Java are registered trademarks of Oracle and/or its affiliates. Other names may be trademarks of their respective owners.

What is claimed is:

1. A method of displaying, on a display screen of a portable electronic device, a graphical user interface (GUI) having a first area enabling a user of the portable electronic device to interact with a display application designed to be unstoppable by the user, and having a second area enabling the user to interact with a second application, the method comprising:
executing, by the portable electronic device, the display application, and a service application, and a plugin application;
executing, by the portable electronic device, a home screen application that is displayed in the second area of the GUI, the home screen application enabling the user to choose the second application for display in the second area of the GUI;
wherein the display application is configured to, at a first regular interval: (1) transmit, to a server via a data network, personal data pertaining to the user, and (2) receive, from the server via the data network, data having been selected by the server as a function of the personal data, and (3) display, in the first area of the GUI, the received data;
wherein the service application is configured to, at a second regular interval: (1) uninstall, from the portable electronic device, any application whose operation interferes with operation of the display application, the service application, or the plugin application, and (2) update the installation of the display application, the service application, or the plugin application, and (3) enable, if disabled, and restart, if stopped, either or both of the display application and the plugin application; and
wherein the plugin application is configured to, at a third regular interval, enable, if disabled, and restart, if stopped, either or both of the display application and the service application.

2. The method of claim 1, wherein executing the display application, or the service application, or the plugin application comprises executing using a permission setting that prevents the user from stopping the application, or disabling the application, or both stopping and disabling the application.

3. The method of claim 1, further comprising, in response to receiving a selection by the user of the first area of the GUI, executing an application that is associated with the data displayed in the first area of the GUI.

4. The method of claim 1, wherein the first regular interval is approximately 30 seconds, or the second regular interval is approximately 10 minutes, or the third regular interval is approximately 5 minutes.

5. The method of claim 1, wherein the service application is further configured to determine the applications whose operation interferes with operation of the display application, the service application, or the plugin application by, according to a fourth regular interval:
transmitting, to the server via the data network, a request to obtain an updated list of such applications; and
receiving, from the server via the data network, a response including data that identify the applications.

6. The method of claim 1, wherein transmitting personal data includes transmitting (1) data that uniquely identify the user to the server, or (2) data that indicate a condition of either or both of the user and the portable electronic device, or (3) a combination of identifying and condition-indicating data.

7. The method of claim 6, wherein (1) the data that uniquely identify the user to the server include an IMEI number, or (2) the data that indicate a condition of the user include an age, gender, or other demographic information of the user, or (3) the data that indicate a condition of the portable electronic device include a location sensed by the portable electronic device, and the method further comprises sensing the location by the portable electronic device.

8. The method of claim 1, wherein receiving data from the server includes receiving an advertisement for display in the first area of the GUI.

9. The method of claim 1, further comprising configuring a size of the first area of the GUI according to a format of the data received by the display application from the server.

10. The method of claim 1, wherein displaying the data received by the display application from the server includes formatting the data for graphical display.

11. A tangible memory in which is non-transitorily stored computer program code for a display application, a service application, and a plugin application, each such application being capable of execution by a portable electronic device, the collective execution of the applications by the portable electronic device resulting in performance of a method of displaying, on a display screen of the portable electronic device, a graphical user interface (GUI) having a first area enabling a user of the device to interact with the display application, and having a second area enabling the user to interact with a second application, the method comprising:
executing, by the portable electronic device, the display application, and the service application, and the plugin application;
executing, by the portable electronic device, a home screen application that is displayed in the second area of the GUI, the home screen application enabling the user to choose the second application for display in the second area of the GUI;
wherein the display application is configured to, at a first regular interval: (1) transmit, to a server via a data network, personal data pertaining to the user, and (2) receive, from the server via the data network, data having been selected by the server as a function of the personal data, and (3) display, in the first area of the GUI, the received data;
wherein the service application is configured to, at a second regular interval: (1) uninstall, from the portable electronic device, any application whose operation interferes with operation of the display application, the service application, or the plugin application, and (2) update the installation of the display application, the service application, or the plugin application, and (3) enable, if disabled, and restart, if stopped, either or both of the display application and the plugin application; and
wherein the plugin application is configured to, at a third regular interval, enable, if disabled, and restart, if stopped, either or both of the display application and the service application.

12. The medium of claim 10, further comprising program code for executing the display application, or the service application, or the plugin application using a permission setting that prevents the user from stopping the application, or disabling the application, or both stopping and disabling the application.

13. The medium of claim 10, further comprising program code for, in response to receiving a selection by the user of the first area of the GUI, executing an application that is associated with the data displayed in the first area of the GUI.

14. The medium of claim 10, wherein the program code for the service application includes program code for determining the applications whose operation interferes with operation of the display application, the service application, or the plugin application by, according to a fourth regular interval:
transmitting, to the server via the data network, a request to obtain an updated list of such applications; and
receiving, from the server via the data network, a response including data that identify the applications.

15. The medium of claim 10, wherein the program code for transmitting personal data includes program code for transmitting (1) data that uniquely identify the user to the server, or (2) data that indicate a condition of either or both of the user and the portable electronic device, or (3) a combination of identifying and condition-indicating data.

16. The medium of claim 15, wherein (1) the data that uniquely identify the user to the server include an IMEI number, or (2) the data that indicate a condition of the user include an age, gender, or other demographic information of the user, or (3) the data that indicate a condition of the portable electronic device include a location sensed by the portable electronic device, and the medium further comprises program code for sensing the location by the portable electronic device.

17. The medium of claim 10, further comprising program code for configuring a size of the first area of the GUI according to a format of the data received by the display application from the server.

18. The medium of claim 10, wherein the program code for displaying the data received by the display application from the server includes program code for formatting the data for graphical display.

19. A portable electronic device comprising:
a touchscreen;
a data network port capable of coupling to a data network for transmission and reception of data with a server;
a sensor capable of determining a location of the portable electronic device;
a microprocessor configured to execute a multitasking operating system, the operating system facilitating data access, by one or more applications, to the touchscreen, and the data network port, and the sensor via an application programming interface (API); and
a memory in which is stored computer program code for a display application, a service application, and a plugin application, each such application being capable of execution by the microprocessor using the API, the collective execution of the applications resulting in performance of a method of displaying, on the touchscreen, a graphical user interface (GUI) having a first area enabling a user of the device to interact with the display application, and having a second area enabling the user to interact with a second application, the method comprising:
executing, by the microprocessor, the display application, and the service application, and the plugin application;
executing, by the microprocessor, a home screen application that is displayed in the second area of the GUI, the home screen application enabling the user to choose the second application for display in the second area of the GUI;
wherein the display application is configured to, at a first regular interval: (1) transmit, to the server via the data network port, personal data pertaining to the user, and (2) receive, from the server via the data network port, data having been selected by the server as a function of the personal data, and (3) display, in the first area of the GUI, the received data;
wherein the service application is configured to, at a second regular interval: (1) uninstall, from the portable electronic device, any application whose operation interferes with operation of the display application, the service application, or the plugin application, and (2) update the installation of the display application, the service application, or the plugin application, and (3) enable, if disabled, and restart, if stopped, either or both of the display application and the plugin application; and
wherein the plugin application is configured to, at a third regular interval, enable, if disabled, and restart, if stopped, either or both of the display application and the service application.

20. The portable electronic device of claim 19, wherein the operating system is configured to execute each application according to a permission setting, and executing the display application, or the service application, or the plugin application comprises executing using a permission setting that prevents the user from stopping the application, or disabling the application, or both stopping and disabling the application.
